(19) United States
(12) Patent Application Publication
(10) Pub. No.: US 2014/0161397 A1
(43) Pub. Date: Jun. 12, 2014

(54) FIBER OPTIC PLUG PACK ASSEMBLY

(71) Applicants: Yuri M. Gallegos, Plainfield, IL (US); Jerry A. Wiltjer, Frankfort, IL (US)

(72) Inventors: Yuri M. Gallegos, Plainfield, IL (US); Jerry A. Wiltjer, Frankfort, IL (US)

(73) Assignee: PANDUIT CORP., Tinley Park, IL (US)

(21) Appl. No.: 14/233,791

(22) PCT Filed: Jul. 19, 2012
(86) PCT No.: PCT/US12/47353

§ 371 Date: Jan. 20, 2014

Related U.S. Application Data
(60) Provisional application No. 61/509,663, filed on Jul. 20, 2011.

(51) Int. Cl. G02B 6/36

(52) U.S. Cl. CPC G02B 6/3616
USPC 385/89

(57) ABSTRACT

Embodiments of the present invention include apparatuses which may enable a simpler and/or more reliable connection or release of fiber optic connectors in multifiber optic receptacle environments. In one embodiment, a plug-pack assembly (1) according to the present invention includes a housing (45) and a plurality of sleds (25) adapted to accept a plurality of fiber optic connectors (30). Such an assembly can be handled as a single component, and may provide a user with an increased level of handling ability. Additional embodiment of assemblies according to the present invention can allow a user to disengage fiber optic connectors without affecting connectivity of nearby connectors.

### TECHNICAL FIELD

The present invention relates to the field of fiber optic cable connector assemblies, and more specifically, to fiber optic plug-pack assemblies for connection of multiple fiber optic connectors at the same time.

### BACKGROUND

The increasing use of fiber optic cables within the telecommunication industry has prompted a rise in the fiber optic connectivity components used to connect the fiber optic cables to their respective connection points. While many of these connection points are adapted for single connectors, many others accept two or more connectors placed in near proximity in rows and/or columns. Examples of multi-connector apparatuses include fiber optic patch panels and switch blades where several rows of closely spaced fiber optic receptacles are configured to receive a plurality of fiber optic connectors.

Although the patch-panel-like configurations provide a means for connecting more than one fiber optic connector in a small space, the very nature of space minimization and the tight spaces between the receptacles and other fiber optic connectors can result in the receptacles being difficult to see or reach. Consequently, these factors may cause a technician to unknowingly connect a connector to a wrong receptacle, improperly engage the connector preventing proper signal propagation, or disconnect the wrong connector. These, and other difficulties experienced by technicians, or other users, working in closely spaced fiber optic connector environments can create longer install times, undesired and unintentional signal loss, and unreliable connections.

Therefore, there is a need for improved apparatuses, methods, and systems which may enable a simpler and/or more reliable connection or release of fiber optic connectors in multi-fiber optic receptacle environments.

### SUMMARY OF THE INVENTION

The present invention is directed to fiber optic plug-pack assemblies which may enable a simpler and/or more reliable connection or release of fiber optic connectors in multi-fiber optic receptacle environments.

Accordingly, in one embodiment, the present invention is a plug-pack assembly that allows multiple LC-style fiber optic connectors (8 or 12 single, or 4 to 6 duplex) to be mounted or removed together on the same piece of telecommunication equipment at the same time.

In another embodiment, the present invention is a plug-pack assembly for use with a plurality of fiber optic connectors where the plug-pack assembly includes a housing, and a plurality of sleds having at least one fiber optic connector removably mounted therein, where the plurality of sleds are removably attached to the assembly housing.

In yet another embodiment, the present invention is a telecommunication system which includes telecommunication equipment with a plurality of receptacles made to accept a plurality of fiber optic connectors; and a plug-pack assembly which includes a housing and a plurality of sleds having at least one fiber optic connector removably mounted therein, where the plurality of sleds are removably attached to the assembly housing.

In still yet another embodiment, the present invention is a plug-pack assembly for use with a plurality of fiber optic connectors where the plug-pack assembly includes: a housing having a housing-base and a lid, the housing-base including a base-web and the lid including a lid-web; and a plurality of sleds having at least one fiber optic connector removably mounted therein, where each of said at least one fiber optic connectors includes a thumb-grip connected to a connector-latch, and where each of said plurality of sleds includes a sled-base and a sled-lever, the sled-lever having a lever-cam adapted to actuate said thumb-grip, where the plurality of sleds are removably attached to the housing, and where compression of at least one of the lid and lid-web and at least one of the housing-base and base-web transmits a compression force to the sled-base and the sled-lever, and causes said lever-cam to actuate the thumb-grip and the connector-latch.

One potential benefit of the present invention is that the plug-pack assembly can allow multiple fiber optic connectors (such as LC connectors) to be connected or disconnected at the same time to adapters or transceiver blocks, potentially reducing or eliminating the confusion and labor of installing each individual connector one by one. Another potential benefit is that each duplex configuration may be removed for maintenance.

### BRIEF DESCRIPTION OF THE DRAWINGS

More detailed and exemplary embodiments of the apparatuses, methods, and systems in accordance with the present invention will be described further, with reference to the following figures, wherein:

FIG. 1 is an isometric view of a plug-pack assembly according to an embodiment of the present invention;

FIG. 2 is an exploded view of a housing of the assembly of FIG. 1;

FIG. 3 is an isometric view showing how a sled is installed into a housing of the assembly of FIG. 1;

FIG. 4 is a partial side cutaway view of the assembly of FIG. 1 showing a sled being secured to a housing;

FIG. 4A is a close-up cutaway view of FIG. 4 showing the sled being secured to the housing;

FIG. 5 is an isometric view of a sled assembly according to an embodiment of the present invention;

FIG. 5A is a close-up cutaway view of a sled-lever of the sled of FIG. 5;

FIG. 6 is an isometric view of a fiber optic connector used in the sled of FIG. 5;

FIG. 7 is an isometric view showing how a fiber optic connector of FIG. 6 is installed into the sled of FIG. 5;

FIG. 8 is a partial side cutaway view of the sled of FIG. 5 with the connector of FIG. 6 installed in a receptacle;

FIG. 9 is a partial side cutaway view of the sled of FIG. 5 with the connector of FIG. 6 being disengaged from a receptacle;

FIG. 10 is a partial side cutaway view of the assembly of FIG. 1 installed in receptacles;

FIG. 11 is a partial side cutaway view of the assembly of FIG. 1 being disengaged from receptacles;

FIG. 12 is a partial side cutaway view of the assembly of FIG. 1 where the housing is disengaging the sled(s);

FIG. 13 is a partial side cutaway view of the assembly of FIG. 1 where the housing is disengaged from the sled(s);

FIG. 14 is a partially exploded rear isometric view of the assembly of FIG. 1;

FIG. 15 is a partially exploded view showing a method of replacing a transceiver according to an embodiment of the present invention;

FIGS. 16 and 17 are isometric view of the a system according to an embodiment of the present invention;

FIG. 18 is a rear isometric view of the assembly of FIG. 1 with a lock-clip removed;

FIG. 19 is a rear isometric view of a lock-clip installed on the housing-base of the assembly of FIG. 1; and

FIG. 20 is a rear isometric view of the assembly of FIG. 1.

### DETAILED DESCRIPTION OF THE INVENTION

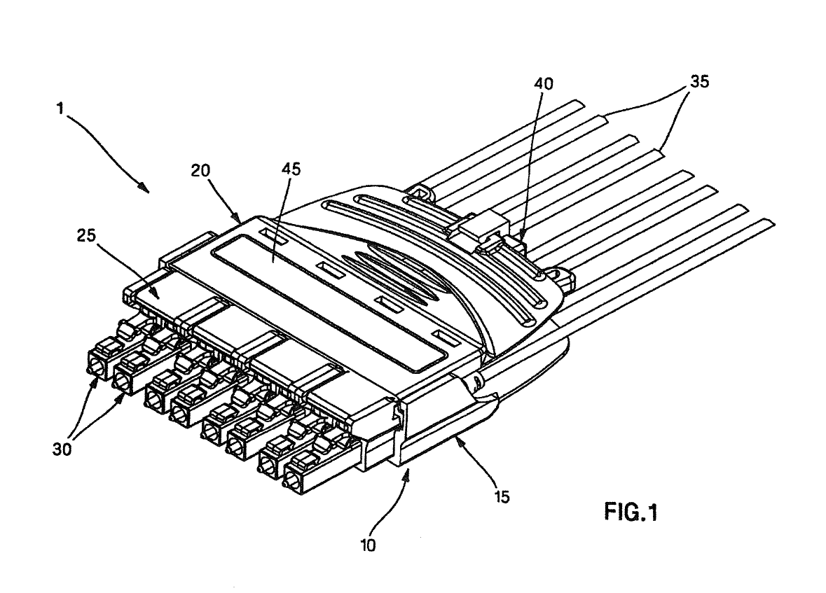

Referring now to FIG. 1, an isometric view of a plug-pack assembly 1 according to one embodiment of the present invention is shown. In this embodiment, the plug-pack assembly includes a housing 10 comprised of a housing-base 15 and a lid 20. The housing-base 15 contains multiple (for example, 2, 4, 6, or 8) cavities for accepting a similar number of sled assemblies 25 therein, with each sled being configured to accept two connectors 30 (as in a duplex configuration). The back of the plug-pack assembly 1 is open to allow one or more fiber cables 35 to pass therethrough and includes a lock-clip 40. The housing 10 also includes an identifier section 45 which acts to provide a surface for a label or other suitable identifier.

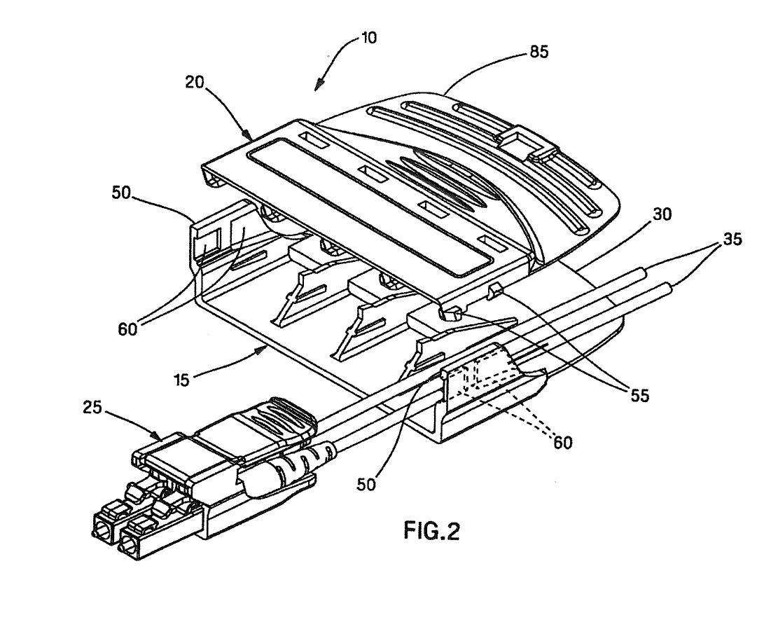

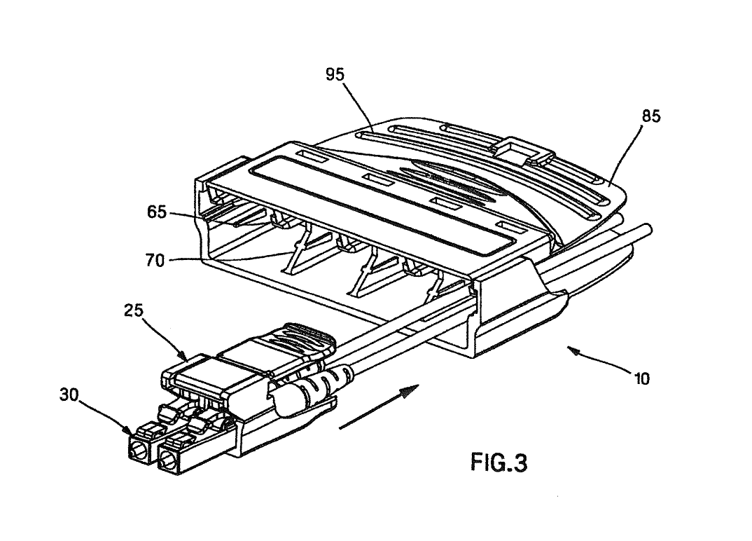

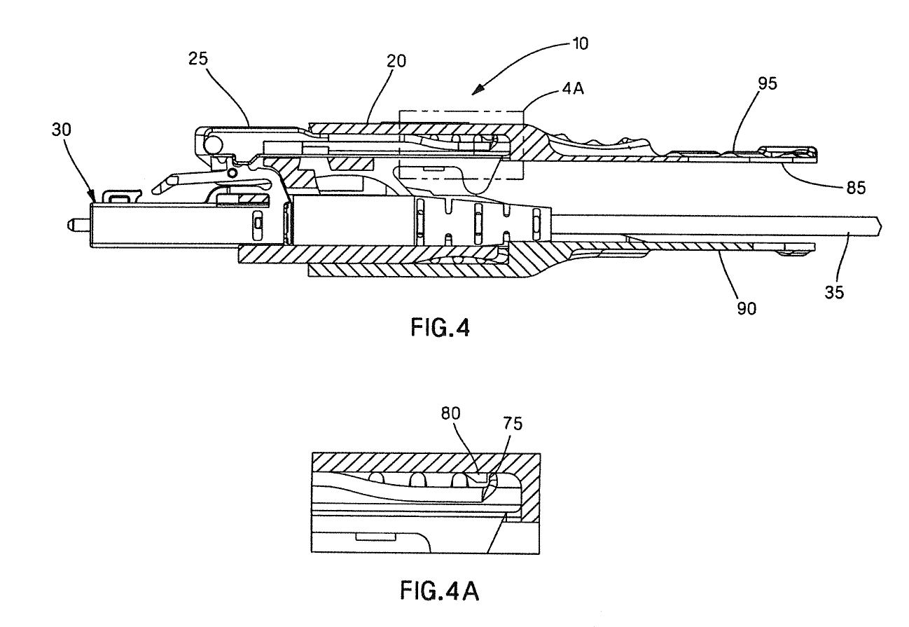

Prior to fully installing the sled assembly 25 into the housing 10, the housing 10 is first assembled. Referring to FIG. 2, the assembly of the housing 10 of the current embodiment involves placing fiber cables 35 between the lid 20 and housing-base 15 and then mounting the lid 20 on the housing-base 15. To mount the lid 20, the sides 50 of the housing-base can be flexed outwardly, allowing catches 55 to fit into the catch-slots 60 located on the sidewalls of the housing-base. Thereafter, the sled assembly 25 can be installed into the housing 10 by sliding the rear portion of the sled assembly into a receiving cavity of the housing, as shown in FIG. 3. To help guide the sled 25 into a correct position, lid-tracks 65 and base-tracks 70 provide a guiding pathway for portions of the sled. Once the sled is fully inserted, it can be locked in position by any suitable locking means. One example of such means is illustrated in FIGS. 4 and 4A, where the top portion of the sled includes a sled-catch 75 and the bottom portion of the lid 20 includes a corresponding retainer 80. When the sled is inserted into the housing, retainer 80 becomes trapped within the sled-catch 75, preventing unintentional separation of the housing 10 and the sled 25.

After all needed sled assemblies 25 with fiber optic connectors 30 are inserted into the housing 10, the entire plug-pack assembly can be handled as a single component, providing a user with an increased level of handling ability. To help a user obtain a good grip, the plug-pack assembly is provided with a lid-web 85 and base-web 90 at the rear section of the plug-pack assembly 1. Both the lid-web 85 and base-web 90 can be made flexible so as not to pinch or damage the fiber 35 when the lid-web and base-web are brought together during disengagement of the plug-pack assembly (described in more detail later in the specification and shown in FIG. 11). Additionally, to increase the available grip, a variety of ridges 95 are provided on the lid-web 85 and/or base-web 90.

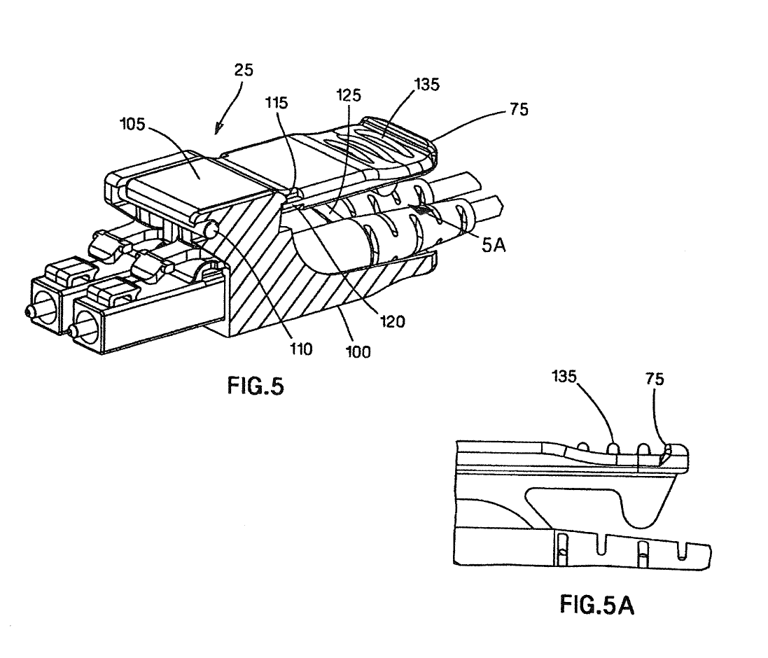

Turning now to FIGS. 5 and 5A, the sled assembly 25 includes a sled-base 100 and a sled-lever 105. The sled-base 100 is hingedly connected to the sled-lever 105 at a hinge 110, allowing the sled-lever 105 to swing open in an upward direction. To prevent the sled-lever 100 from opening unintentionally, a limiter 115 protrudes rearwardly from the upper portion of the sled-base, and retains a sled-lever notch 120 thereunder when the sled-lever 105 is in a downward neutral (also referred to as closed or locked) position. The sled-lever 105 includes a spring-arm 125 which provides a spring force against the sled-base 100, and allows the sled-lever 105 to return to or remain in a neutral position. The sled-lever further includes a sled-grip 135 which may allow the user to more easily grasp and handle the sled 25 during its engagement or disengagement to and from the telecommunication equipment.

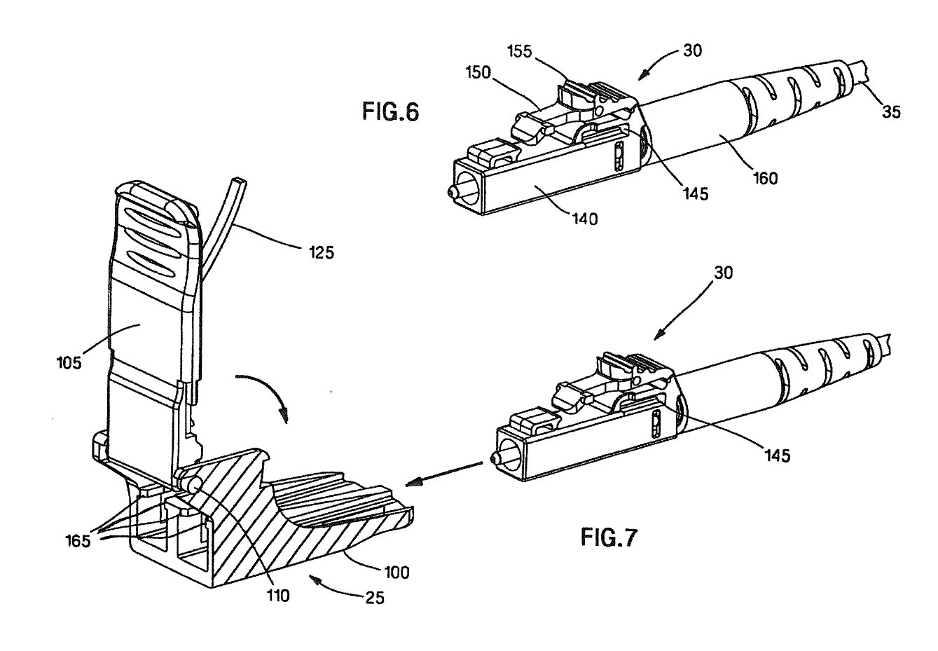

FIG. 6 shows an embodiment of a fiber optic connector 30 that can be used in conjunction with the sled and housing of the present invention. The connector described in this embodiment is an LC connector, and includes a connector-housing 140, generally rectangular cavities 145, a connector-latch 150, a thumb-grip 155, and a boot 160. Connector 30 can be installed on any suitable optical fiber 35, including a single mode or a multimode optical fiber. Furthermore, connectors used in embodiments of the present invention can be single-fiber and/or multi-fiber connectors.

The installation of the connector 30 into the sled 25 is illustrated in FIG. 7. As noted earlier, hinge 110 allows the sled-lever 105 to open by swinging in an upward direction relative to the sled-base 100. This provides access to the interior of the sled 25, and allows a user to insert connector 30 into a respective cavity of the sled 25, as generally represented by the straight arrow in FIG. 7. If installing two connectors, both connectors are inserted into their respective, adjacently placed cavities. The connector 30 is locked in place by sled-ribs 165 on both sides of the sled-base. The sled-ribs 165 fit inside the generally rectangular cavities 145 of the connector 30 and hold the connector securely in place. Once the connector 30 is inserted into the respective cavity of the sled 25, the sled-lever 105 can be closed (completing the sled assembly) by bringing the sled-lever down into a locked position which is generally parallel with the fiber optic connector.

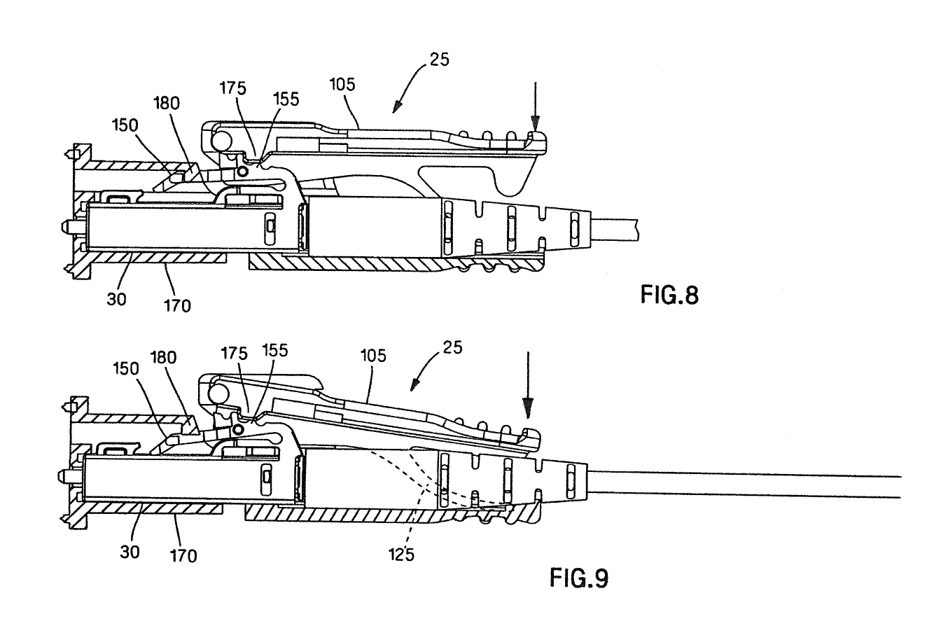

The configuration of the currently described embodiment of the sled allows the user to disengage connector 30 from an adapter receptacle without directly engaging the connector 30. As illustrated in FIG. 8, when connector 30 is installed into an adapter receptacle 170, it is generally locked in position by the connector-latch 150. To cause the connector-latch 150 to disengage from the adapter receptacle 170, it is necessary to depress the sled-lever 105 in a downward direction, as shown in FIG. 9, making the lever-cam 175 press on the thumb-grip 155. The downward deflection of the thumb-grip in turn moves the connector-latch 150, freeing the sled 25.

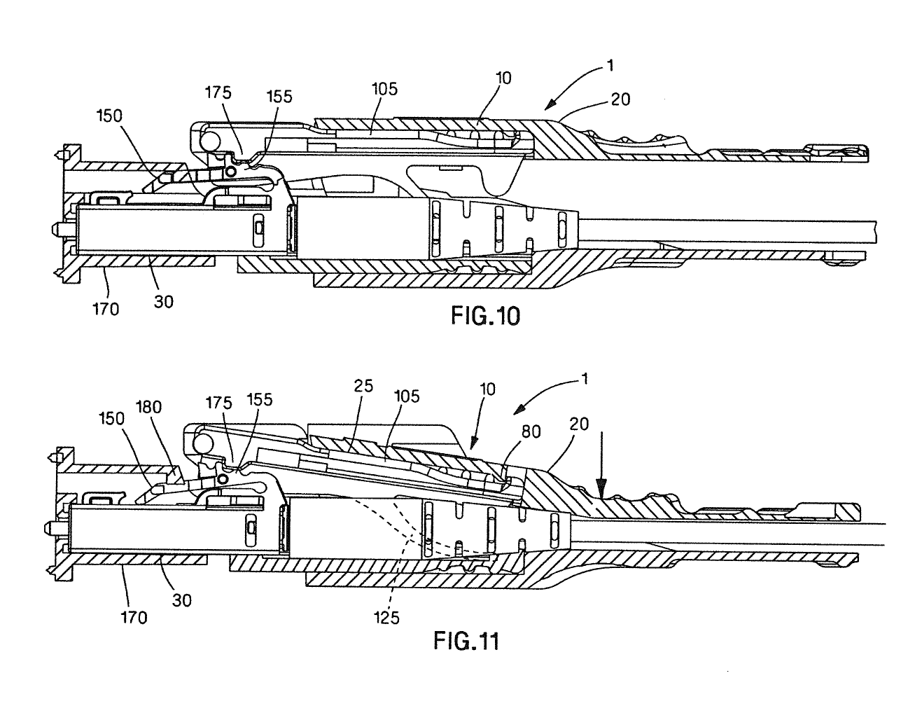

Similar principles apply to engaging and disengaging the entire plug-pack assembly from multiple receptacles of adapters or transceivers. FIG. 10 illustrates a plug-pack assembly 1 installed in the receptacles 170 of adapters or transceivers, and FIG. 11 illustrates the disengagement of a plug-pack assembly 1 from the receptacles 170 of adapters or transceivers. To disengage the plug-pack assembly 1 from receptacles 170, the user depresses the lid 20 which transmits the force to the sled-lever(s) 105 of the one or more sleds 25 installed in the plug-pack assembly. The downward force transmitted to the sled-lever(s) 105 in turn deflects the thumb-grip(s) 155 of the connectors then-installed in the plug-pack assembly, and thereby causes connector-latch(es) 150 to also move in the downward direction. The connector-latch(es) 150 thereby disengage from the adapter or transceiver receptacle-catches 180, leaving the plug-pack 1 free to be removed. The sled spring-arm 125 provides a spring force that allows the sled-lever 105 and lid 20 to return to their locked positions after removal. The retainer 80 on the bottom portion of the lid 20 prevents the sled-assembly(ies) 25 from sliding out while pressing on the lid 20 during the installation or removal of the assembly from receptacles 170. The plug-pack of the present invention can be mounted on one or more transceivers such as the ones being arranged in switch-blades or line-cards.

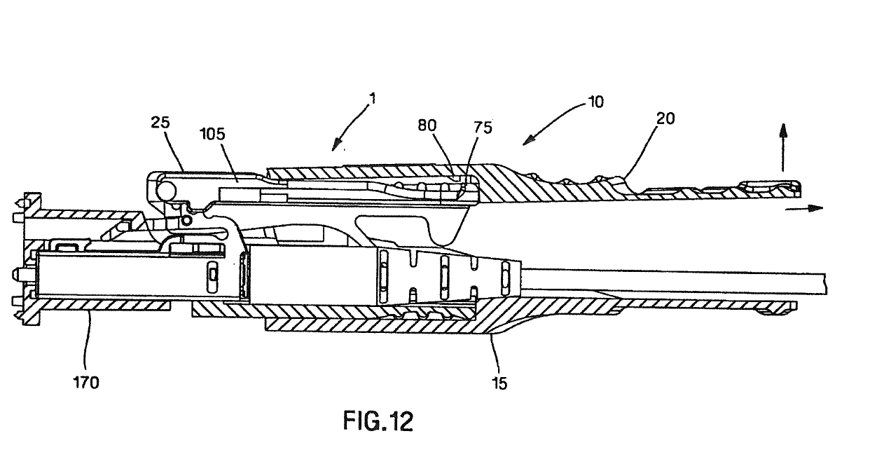

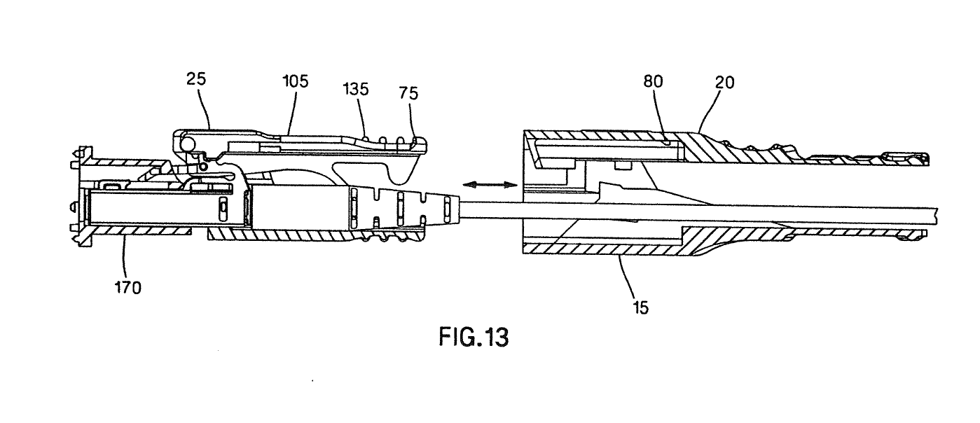

The currently described embodiment also permits the housing 10 of the plug-pack assembly 1 to be separated from the sled assemblies 25 when the entire plug-pack assembly is installed in a blade, adapter, transceiver, or other electronic equipment, allowing the sled assemblies (together with fiber optic connectors) to remain installed in the equipment. Such configuration can allow a user to disconnect one or more sled assemblies 25 from the equipment, and if necessary, reinstall the housing 10, effectively disconnecting and removing only the necessary sled assemblies from plug-pack assembly, without breaking the connectivity of the remaining fiber optic connectors. This is illustrated in FIGS. 12 and 13. To disengage the housing 10 from the sled assemblies 25, the user lifts the lid 20 and pulls until the retainer 80 disengages the sled-catch 75, allowing the user to remove the lid 20 and housing-base 15. Thereafter, the user can press on the sled-lever 105 (as shown in FIG. 9) and pull backward on the on the sled-grip 135 to disconnect the connectors from the adapter 170. This removal may, for example, be done to clean individual connectors or to replace defective cords. A sled can be installed in the same way by removing the lid 20 and housing-base 15, and sliding the sled into position until the connector-latch 150 of the fiber optic connector engages on the adapter catch 180. The lid 20 and housing-base 15 are then reinstalled so that the sled-catch 75 fits on the retainer 80 of the lid 20.

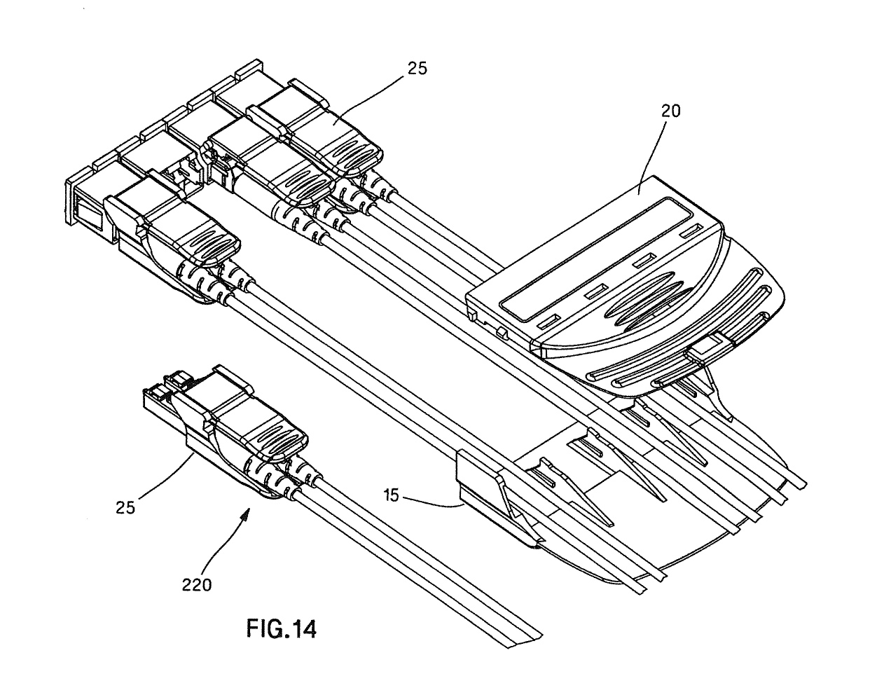

FIG. 14 is another illustration of how the lid 20 and housing-base 15 can be disassembled to remove an individual duplex patch-cord 220 from a blade without disturbing the connectors next to it. Once the cleaning or replacement operation has finished, the patch-cord 220 can be put back in the empty position and the lid 20 and housing-base 15 can slide back into place over the sleds 25.

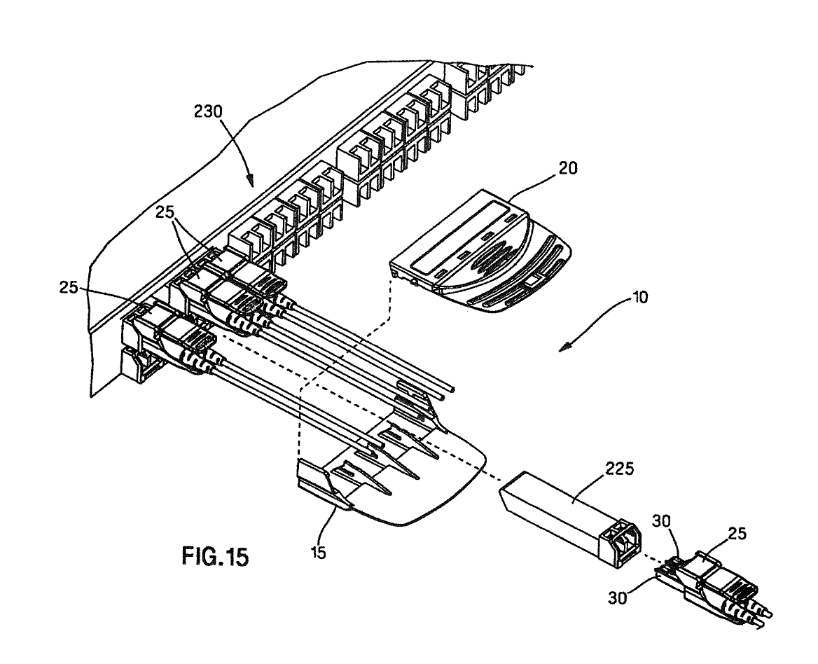

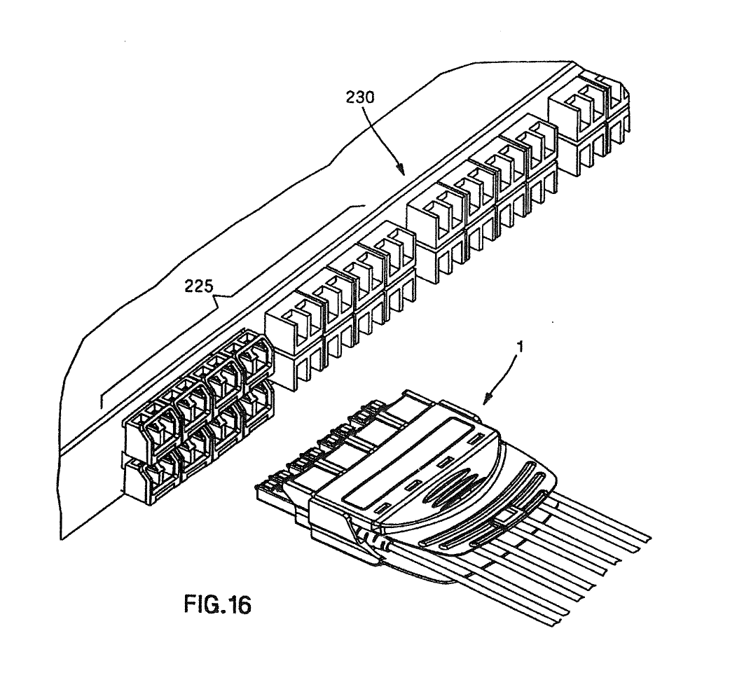

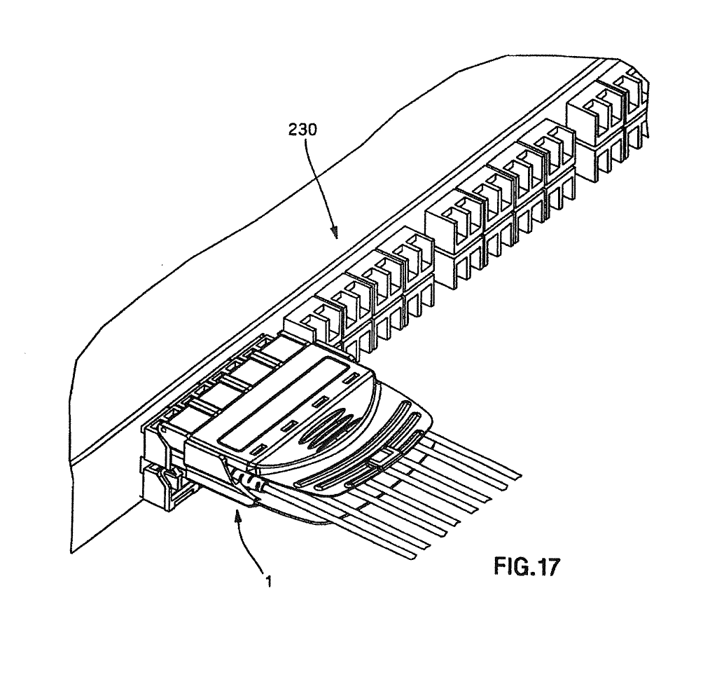

FIG. 15 depicts how an individual transceiver 225 can be removed from a switch-blade 230 while employing an embodiment of a plug-pack assembly according to the present invention. This can be accomplished by removing the housing 10 (as previously described) from the sleds 25 connected to the switch-blade, taking apart the lid 20 and the housing-base 15 of the housing 10, and disconnecting any particular sled 25 (as previously described) from the switch-blade to gain access to a specific transceiver 225. The specific transceiver 225 can then be removed and replaced. Thereafter, the fiber optic connectors 30 provided on the removed sled 25 are inserted into the new transceiver 225, and the housing 10 is reassembled and installed on the sleds to restore plug-pack functionality. Alternatively, the sled and the transceiver can be removed from and/or reinstalled into the switch-blade while connected to each other. Where permissible, the order of the steps can be varied depending on the preference of the user or the ease of accessibility to the equipment. One advantage of this configuration is that a transceiver can be replaced using the described procedure without interfering with the communication of the other (neighboring) transceivers of the switch-blade or similar equipment. Once the assembly 1 is put back together, it can be removed from the transceivers 225 as a whole and installed as one unit, as shown in the system illustrated in FIGS. 16 and 17.

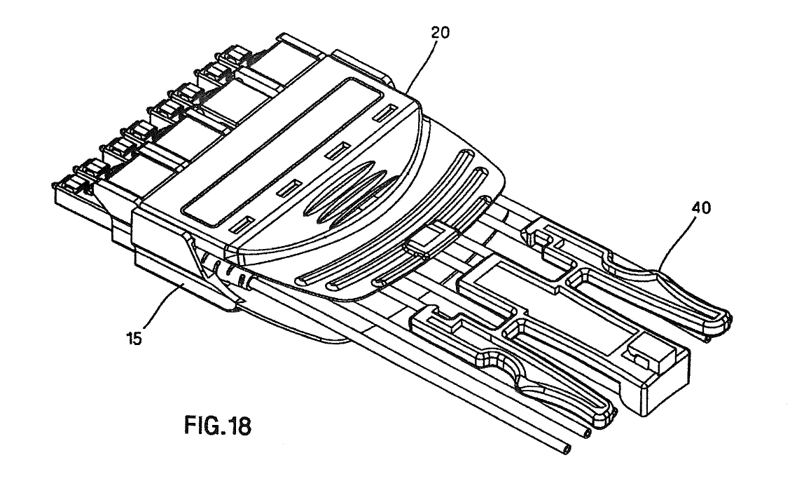

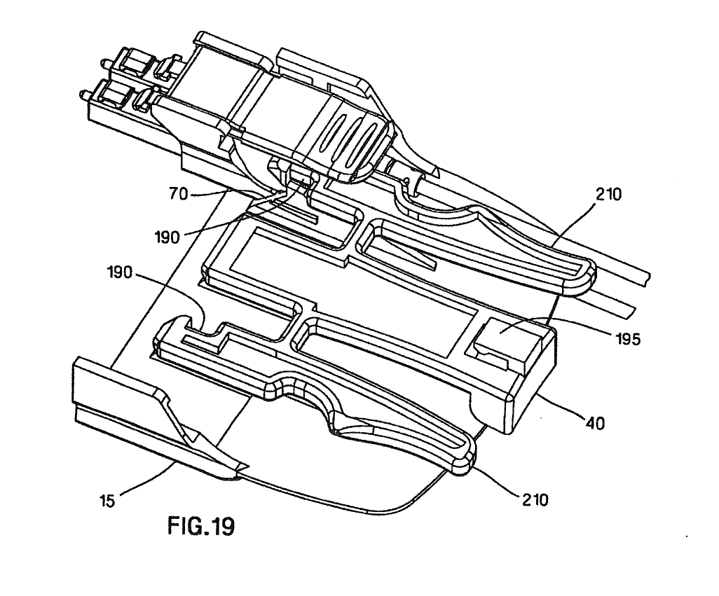

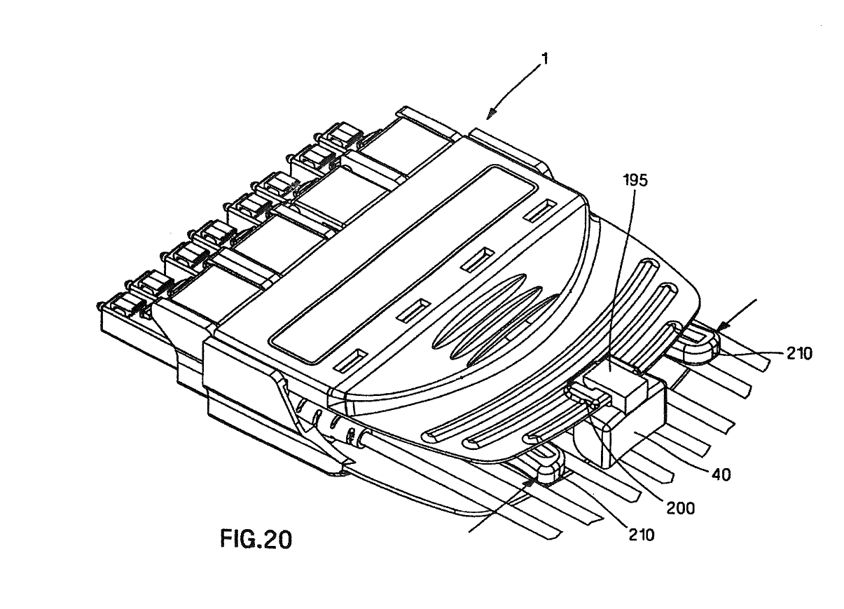

To prevent unintentional disconnection of the plug-pack 1, the lock-clip 40, illustrated in detail in FIGS. 18-20, can be installed between the lid 20 and the housing-base 15, preventing the lid from depressing the sled-levers and disengaging the connectors. The lock-clip 40 has hooks 190 on both sides that hook onto (or otherwise fit over and around) the base-tracks 70 of the housing-base 15. Further, a lock-catch 195 latches onto a window 200 of the lid 20, holding the lock-clip in place. To remove the lock-clip 40, the user depresses (squeezes/compresses) the lock-levers 210 and pulls the lock-clip from the plug-pack 1. To secure the lock-clip further, it is also possible to wire-tie the lock-clip 40 to the lid 20 thru the window 200.

Note that while this invention has been described in terms of one or more embodiment(s), these embodiment(s) are non-limiting, and there are alterations, permutations, and equivalents, which fall within the scope of this invention. It should also be noted that there are many alternative ways of implementing the systems, methods, and apparatuses of the present invention. It is therefore intended that claims that follow be interpreted as including all such alterations, permutations, and equivalents as fall within the true spirit and scope of the present invention.

We claim:

1. A plug-pack assembly for use with a plurality of fiber optic connectors, said plug-pack assembly comprising:
a housing; and
a plurality of sleds having at least one fiber optic connector removably mounted therein, wherein said plurality of sleds are removably attached to said housing.

2. The plug-pack assembly of claim 1, wherein said housing comprises a housing-base and a lid.

3. The plug-pack assembly of claim 2, wherein said housing-base comprises a base-web, said lid comprises a lid-web, and
wherein at least one of said housing-base, lid, base-web and said lid-web is flexible.

4. The plug-pack assembly of claim 2, wherein said housing-base comprises base-tracks, said lid comprises lid-tracks, and
wherein said base-tracks and said lid-tracks help guide said plurality of sleds when said plurality of sleds are removably attached to said housing.

5. The plug-pack assembly of claim 1, wherein said housing comprises a retainer, at least one of said plurality of sleds comprises a sled-catch, and
wherein said sled-catch traps said retainer when said at least one of said plurality of sleds is removably attached to said housing.

6. The plug-pack assembly of claim 1, wherein at least one of said sleds comprises:
a sled-base; and
a sled-lever, wherein said sled-lever is hingedly attached to said sled-base.

7. The plug-pack assembly of claim 6, wherein said at least one fiber optic connector comprises a thumb-grip, said sled-lever comprises a lever-cam, and
wherein said lever-cam actuates said thumb-grip in response to movement of said sled-lever.

8. The plug-pack assembly of claim 6, wherein said sled-base comprises a limiter, said sled-lever comprises a notch, and
wherein said limiter at least partially retains movement of said sled-lever by at least partially restraining movement of said notch.

9. The plug-pack assembly of claim 6, wherein said sled-lever comprises a spring-arm and wherein said spring-arm provides a spring force against said sled-base.

10. The plug-pack assembly of claim 1, wherein at least one of said sleds comprises at least one sled-rib, said at least one fiber optic connector comprises at least one generally rectangular cavity, and
wherein said at least one fiber optic connector is at least partially secured inside said at least one of said sleds by said at least one sled-rib fitting inside said at least one generally rectangular cavity.

11. The plug-pack assembly of claim 1, wherein said at least one fiber optic connector is an LC-style fiber optic connector.

12. The plug-pack assembly of claim 1 further comprising a lock-clip removably positioned at least partially inside said housing, said lock-clip preventing compression of at least a portion of said housing.

13. The plug-pack assembly of claims 12, wherein said housing comprises a housing-base and a lid, said housing-base having a base-web and said lid having a lid-web, and
wherein said lock-clip is positioned at least partially between said base-web and said lid-web.

14. The plug-pack assembly of claim 13, wherein said housing-base further includes a plurality of base-tracks, said lock-clip includes a plurality of hooks hooked onto said plurality of base-tracks, and
wherein said lock-clip is at least partially secured within said housing by said plurality of hooks.

15. The plug-pack assembly of claim 14, wherein said lock-clip further includes a lock-catch, said lid-web includes a window, and
wherein said lock-clip is further secured within said housing by having said lock-catch latch onto said window.

16. The plug-pack assembly of claim 14, wherein said lock-clip further includes a plurality of lock-levers, and wherein applying a compressive force to said lock-levers releases said plurality of hooks from said plurality of base-tracks.

17. A telecommunication system comprising:
telecommunication equipment having a plurality of receptacles made to accept a plurality of fiber optic connectors therein; and
the plug-pack assembly of claim 1 connected to said plurality of receptacles.

18. A plug-pack assembly for use with a plurality of fiber optic connectors, said plug-pack assembly comprising:
a housing having a housing-base and a lid, wherein said housing-base includes a base-web and said lid includes a lid-web; and
a plurality of sleds having at least one fiber optic connector removably mounted therein,
each of said at least one fiber optic connectors having a thumb-grip connected to a connector-latch,
each of said plurality of sleds including a sled-base and a sled-lever, said sled-lever having a lever-cam adapted to actuate said thumb-grip,
wherein said plurality of sleds are removably attached to said housing, and
wherein compression of at least one of said lid and lid-web and at least one of said housing-base and base-web transmits a compression force to said sled-base and said sled-lever, and causes said lever-cam to actuate said thumb-grip and said connector-latch.

19. The plug-pack assembly of claim 18 further comprising a lock-clip removably positioned at least partially between said base-web and said lid-web, said lock-clip preventing compression of at least a portion of base-web and said lid-web.

20. The plug-pack assembly of claim 19, wherein
said housing-base further includes a plurality of base-tracks,
said lock-clip includes a plurality of hooks, said plurality of hooks hooking onto said plurality of base-tracks, and
wherein said lock-clip further includes a plurality of lock-levers connected to said plurality of hooks, said plurality of lock-levers releasing said plurality of hooks from said plurality of base-tracks when said plurality of lock-levers are compressed.
